(19) United States
(12) Patent Application Publication
(10) Pub. No.: US 2012/0324018 A1
(43) Pub. Date: Dec. 20, 2012

(54) SYSTEMS AND METHODS FOR LOCATION BASED SOCIAL NETWORK

(75) Inventors: Michael Metcalf, San Francisco, CA (US); Jeremy Osborne, Santa Clara, CA (US); Pradhap Nirmal Natarajan, Sunnyvale, CA (US); Alexander Shusta, Redwood City, CA (US)

(73) Assignee: Yahoo! Inc., Sunnyvale, CA (US)

(21) Appl. No.: 13/162,339

(22) Filed: Jun. 16, 2011

(51) Int. Cl. G06F 15/16

(52) U.S. Cl. 709/206

(57) ABSTRACT

A first request for a creation of a social networking space is received, over a network, from a first user. The first request comprises a geospatial location, a start time, and an end time. A social networking space is creating, using a computing device, based on the request. The social networking space comprises facilities for posting messages visible to users signed into the social networking space. A second request is received, over the network, from second user to sign into the social networking space. The second request is transmitted from a mobile device associated with the second user. It is verified, using the computing device, that a first current time falls between the start time and the end time. It is further verified, using the computing device, that a first current geospatial position of the mobile device is within the geospatial location. In response to verifying the first current time and the first current geospatial position, the second user is signed into the social networking space.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to systems and methods for social networking services, and more particularly, to social networking services tied to specific geospatial locations.

### BACKGROUND OF THE INVENTION

Social networking sites allow users to interact with one another online relating to a variety of topics. Typically, such sites only allow users to interact with other users that are on a predefined social graph. Users may, however, wish to interact with other users that are not on their social graph who are attending various events tied to a specific location, such as a conference or a concert.

### SUMMARY OF THE INVENTION

In an embodiment, the invention is a method and a computer-readable storage media for tangibly storing thereon computer-readable instructions for a method. A first request for a creation of a social networking space is received, over a network, from a first user. The first request comprises a geospatial location, a start time, and an end time. A social networking space is creating, using a computing device, based on the request. The social networking space comprises facilities for posting messages visible to users signed into the social networking space. A second request is received, over the network, from second user to sign into the social networking space. The second request is transmitted from a mobile device associated with the second user. It is verified, using the computing device, that a first current time falls between the start time and the end time. It is further verified, using the computing device, that a first current geospatial position of the mobile device is within the geospatial location. In response to verifying the first current time and the first current geospatial position, the second user is signed into the social networking space using the computing device.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 provides a high-level conceptual overview of an embodiment of a geospatially and temporally limited social networking space (“bubble”).

FIG. 2 illustrates an embodiment of a message board provided by a bubble and adapted to be displayed on a smart phone.

FIG. 3 illustrates an embodiment of a message entry dialog provided by a bubble and adapted to be displayed on a smart phone.

FIG. 4 illustrates an embodiment of a user interface providing a bubble creation dialog.

FIG. 5 illustrates an embodiment of a user interface providing a bubble type selection dialog.

FIG. 6 illustrates an embodiment of a user interface providing a bubble location selection dialog.

FIG. 7 illustrates an embodiment of a bubble search dialog.

FIG. 8 illustrates an embodiment of a display of a “My” tab on a bubble search dialog.

FIG. 9 illustrates a number of possible shapes for a bubble.

FIG. 10 illustrates one possible three-dimensional bubble encompassing two floors of a skyscraper.

FIG. 11 illustrates an embodiment of a bubble whose size and centroid changes as users join the bubble or move.

FIG. 12 illustrates a high-level view of an embodiment of a system capable of supporting various embodiments of the systems and methods described herein.

FIG. 13 illustrates a computer-implemented processes for creating a geospatially and temporally limited social networking space.

FIG. 14 illustrates a computer-implemented process for posting messages to geospatially and temporally limited social networking space.

FIG. 15 is a block diagram illustrating an internal architecture of an example of a computing device.

### DETAILED DESCRIPTION

The present invention is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions.

These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

Reference in this specification to “an embodiment” or “an embodiment” or “some embodiments” means that a particular feature, structure, or characteristic described in connection with the embodiment is included in at least an embodiment of the disclosure. The appearances of the phrase “in an embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments, but not other embodiments.

For the purposes of this disclosure, the term “server” should be understood to refer to a service point that provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure a computer-readable medium stores computer data, which data can include computer program code that is executable by a computer, in machine readable form. By way of example, and not limitation, a computer-readable medium may comprise computer-readable storage media, for tangible or fixed storage of data, or communication media for transient interpretation of code-containing signals. Computer-readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer-readable storage media includes, but is not limited to, RAM (random access memory), ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

In various embodiments, the presently disclosed systems and methods provide for the creation of geographically and temporally bounded social networking spaces hereinafter referred to as bubbles. Bubbles enable people who are sharing an experience, event, and/or space to collaborate and communicate based not on a predefined social graph, but on their proximity to one another.

For example, business travelers arriving at an airport can collaborate to find others going to the same destination. Singles can find other singles at a bar based on their status. Sports fans can chat with others in their immediate vicinity about a game. And concert goers with lousy seats can see photos shared in the bubble by people in the front row. Wedding guests can post their best wishes and photos centrally in a private bubble without any setup time or costs.

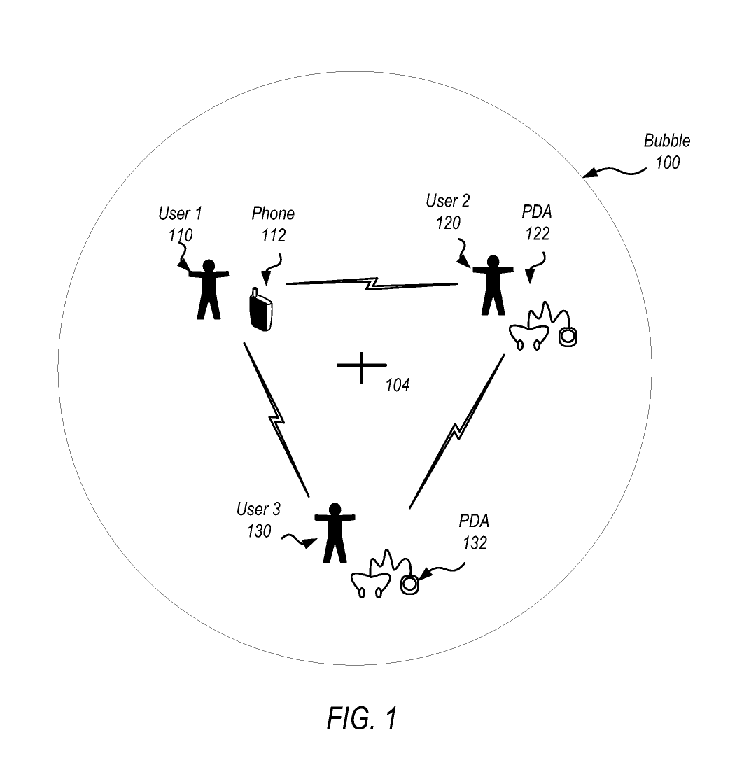

FIG. 1 provides a high-level conceptual overview of an embodiment of a bubble. Three users 110, 120 and 1330 are located within a bubble 100. The bubble 100 is tied to a specific location at the bubble's geographic center. Each of the user's has a device 112, 122, and 132 whose geographic location is known or can be determined. While within the bubble 100, the users 110, 120 and 130 can communicate with one another via a social networking space associated with the bubble. When a user steps outside the radius of the bubble, the user is no longer able to communication with other users via the social networking space associated with the bubble. In one embodiment, the bubble 100 can be additionally be temporally constrained such that it has a start time and an end time. The users 110, 120 and 1330 cannot enter the bubble before the start time, and after the end time the bubble “pops” (i.e. expires), and the users 110, 120 and 1330 are no longer connected with one another.

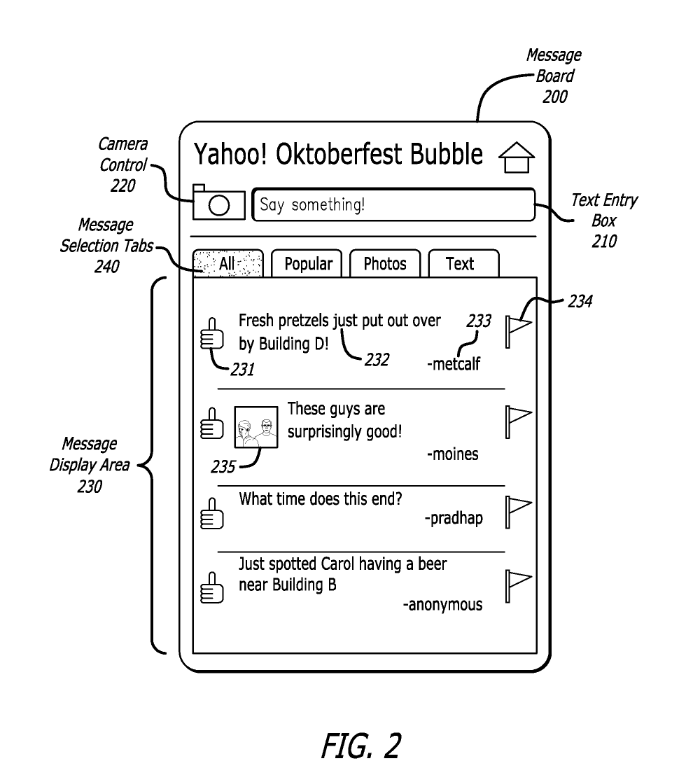

The social networking space provided by a bubble can provide various types of functionality to allow users to communicate and collaborate with one another. For example, the social networking space may provide a message board 200 adapted to be displayed on a smart phone as shown in FIG. 2. The message board 200 provides a text entry box 210 that allows users to enter text for a message to be posted to the board. The message board 200 additionally provides a camera control 220 that allows users to take a picture or video with their smart phone and associates the resulting image with a message posted to the board.

Messages posted to the message board 200 are displayed in a message display area 230. Each message has a voting button 231 associated with it that allows users to vote up or down on the message. Each message may additionally have message text 232 entered by the originating user. Each message additionally has a signature 233 that may reflect the identity of the user entering the message, or may be signed as anonymous. Each message may additionally have a signal flag 234 reflecting a relative importance attached by the user to the message. Each message may additionally have an associated image 235, which may have originated from the posting users smart phone, or may have originated from some other source accessible to the smart phone, such as a website. In an embodiment, bubbles can use voting for self-policing. For example, any user—whether anonymous or not—who receives a “down” vote from three or more users within the bubble can be banned from that bubble.

In an embodiment, messages posted to the message board 200 may consist of only text, only image or both. In an embodiment, the interface can additionally provide message selection tabs 240 that allow the user to display various categories of messages, including text messages, messages with images and messages sorted by popularity (e.g. most “up” votes). In other embodiments, bubbles may be enabled to allow the posting of any type of digital content, such as videos, document files, audio files and so forth.

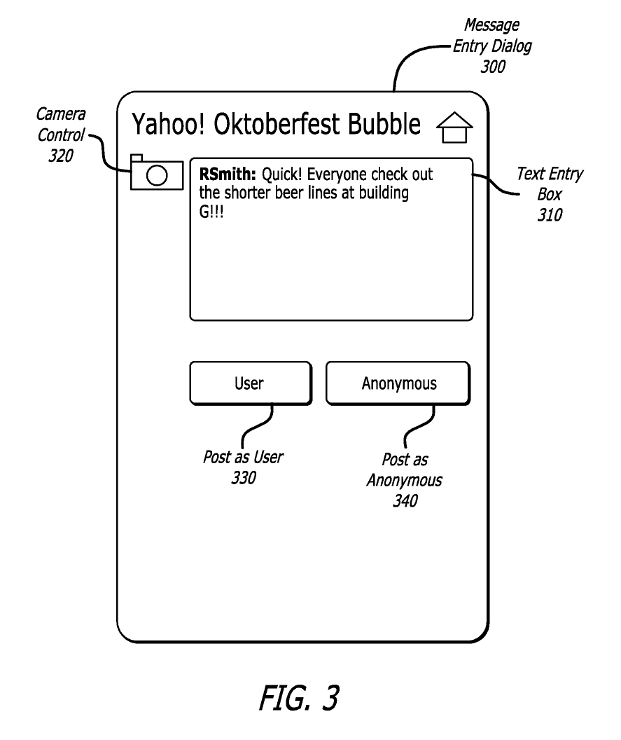

FIG. 3 illustrates an embodiment of another message entry dialog 300 that the social networking space can provide. The message entry dialog 300 provides a text entry box 310 that allows users to enter text for a message to be posted to the board. The message entry dialog 300 additionally provides a camera control 320 that allows users to take a picture with their smart phone and associates the resulting image with a message posted to the board. The message entry dialog 300 additionally provide two buttons 330 and 340 that allow the user to post the message signed as the user and signed as anonymous, respectively.

In an embodiment, users must sign into a bubble in order to access the social networking space associated with the bubble, even if they choose to send messages and post content anonymously. In an embodiment, a user must be physically located inside the bubble's geospatial boundaries to sign into the bubble.

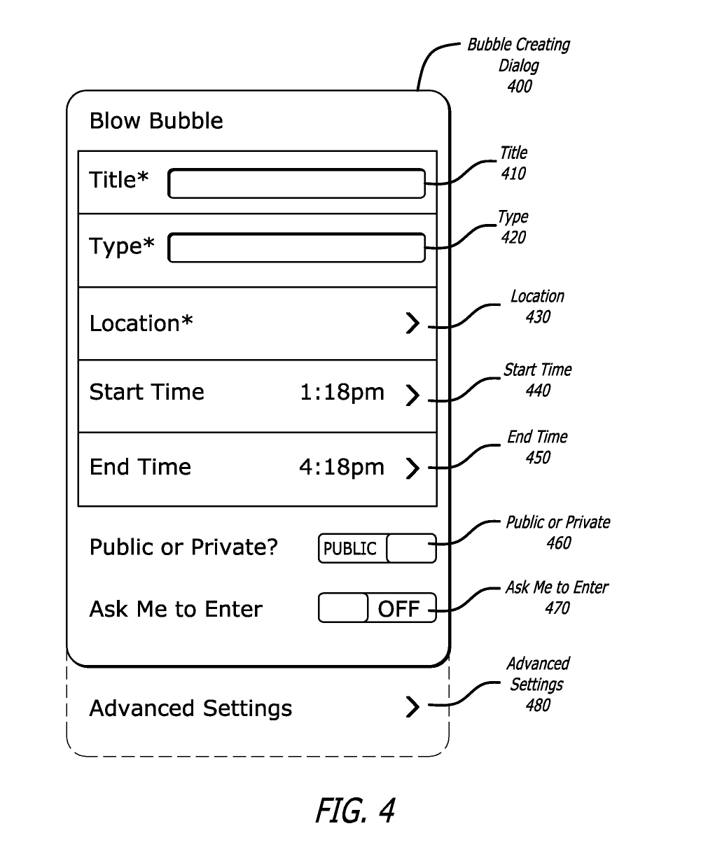

In an embodiment, bubbles can be created dynamically by users via their location aware mobile devices. FIG. 4 illustrates an embodiment of a bubble creation dialog 400. The bubble creation dialog 400 provides a freeform text entry box 410 that allows users to enter a title for the bubble. The bubble creation dialog 400 additionally provides a text entry box 420 that allows users to enter a type for the bubble. The bubble type 420 generally reflects the purpose of the or the content of the bubble.

For example, bubble types could be:
events such as concerts, conferences, education/classroom, sports and weddings;
news such as neighborhood news and politics;
local information such as deals and/or happy hours, restaurant wait lists, politics and tips;
polls for polling (geospatially) nearby people;
transit such as share a taxi from airport, traffic up ahead, carpooling and public transit;
help finding people at event and directions;
arts history, photography location-based prose and stories and videos;
social uses such as find single people nearby, a party, making sure kids got home safely, family-friendly activities nearby; or
travel and tourism information such as recommendations from locals and upcoming events.

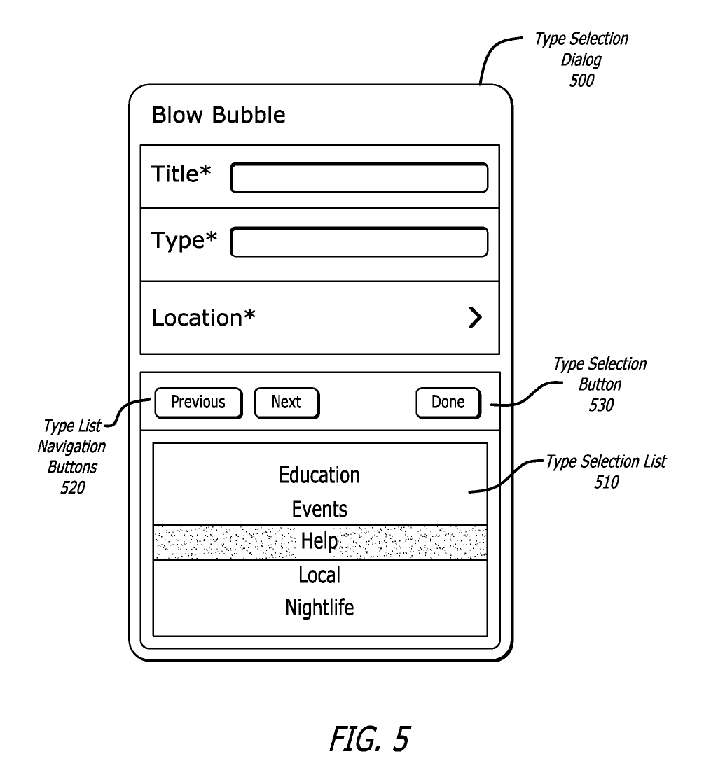

In an embodiment, the text entry box for bubble type 420 is a freeform text entry box, and users can create their own user-defined types. In an embodiment, bubble types are predefined and can be selected using a type selection dialog 500 such as shown in FIG. 5. The type selection dialog provides a scrolling list 510 of available bubble types. A user can scroll through the list using navigation buttons 520, and can select the highlighted type by selecting the type selection button 530.

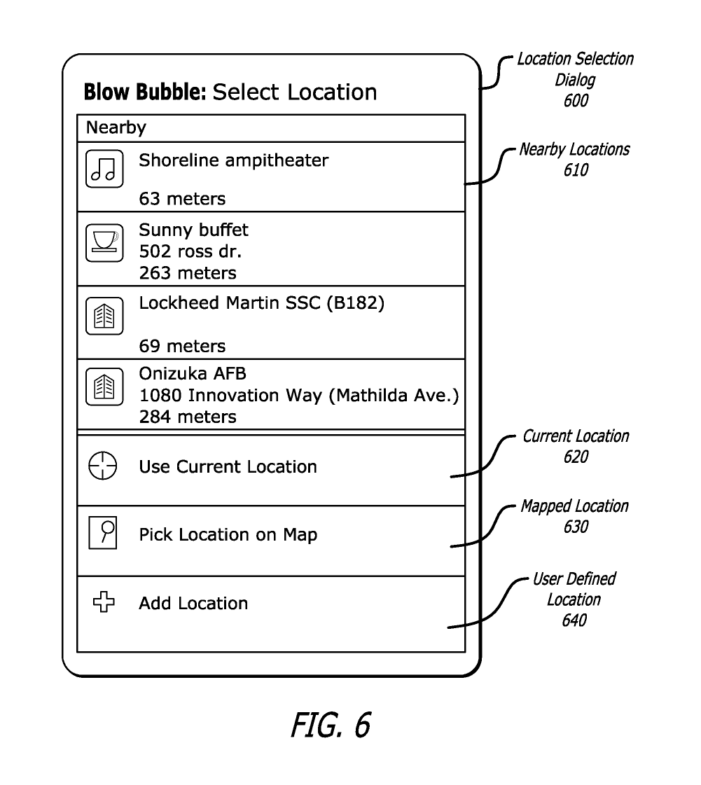

Referring back to FIG. 4, the bubble creation dialog 400 additionally provides a bubble location control 420 that, in an embodiment, launches a location selection dialog 600 such as shown in FIG. 6. The location selection dialog 600 can include a list of nearby locations 610 that are known to the bubble creation service. In an embodiment, such nearby locations 610 could be defined in one or more databases accessible to the bubble creation service, such as, for example, a publicly accessible mapping database or directory service. In an embodiment, such nearby locations 610 could be user-defined locations that are associated with a specific user.

The location selection dialog 600 can additionally include a current location control 620 that sets the bubble location to be the current or last known geographical location of the mobile device. The location selection dialog 600 can additionally include a mapped location control 630 that allows a user to select a bubble location on a map (not shown). The location selection dialog 600 can additionally include a user-defined location control 640 that allows a user to select create a user-defined location by, for example, entering a mailing address or GPS coordinates.

In an embodiment, the center of a bubble created using the above interface is initially set at the selected location. The geospatial boundaries of the bubble (e.g. a radius) can be determined in a number of different ways. In an embodiment, an appropriate radius can be determined using data relating to locations defined in a database, such as, for example, a publicly accessible mapping database or directory service. For example, the approximate size of a business location could be estimated using mapping data, or could be determined from tax records. In an embodiment, the radius of a bubble could be initially be assigned a default value, which could vary depending on the number of users in the bubble. In an embodiment, the location selection dialog 600 or the bubble creation dialog 400 could provide user interface elements (not shown) to permit users to expressly set the size of a bubble.

Referring back to FIG. 4, the bubble creation dialog 400 additionally provides a controls for providing a start time 440 and an end time 450 for the bubble. In an embodiment, before the start time 440, no messages or any type of content can be posted to the bubble, and no users can sign into the bubble. In an embodiment, before the start time 450 messages and other types of content can only be posted to the bubble by the bubble creator and other users can sign into the bubble, but cannot post content or messages.

In an embodiment, after the end time 450, no messages or any type of content can be posted to the bubble, and no users can sign into the bubble. In an embodiment, all messages and content posted to a bubble is archived, and can be viewed at a later point in time, but no new content can be added.

In an embodiment, the bubble creation dialog 400 additionally provides a control 460 to determine if a bubble is public or private. In an embodiment, if a bubble is flagged as public, any user can sign into the bubble and post messages and content to the bubble. In an embodiment, if a bubble is flagged as private, access to the bubble is restricted to a limited number of users. Private bubbles can enable the formation of groups with high-trust (wedding, college classroom, parties) where only a fraction of the users present are formally in each other's social graph. In an embodiment, access to a private bubble can be restricted by providing selected users an access code for the bubble. In an embodiment, access to a private bubble can be restricted by sending selected users an electronic invitation to the bubble.

In an embodiment, the bubble creation dialog 400 additionally provides a control 470 to determine if a user must ask the bubble creator for permission to enter the bubble. In an embodiment, the bubble creation dialog 400 additionally provides a control 480 to allow users to specify advanced option for the bubble, for example, disabling anonymous messaging within the bubble.

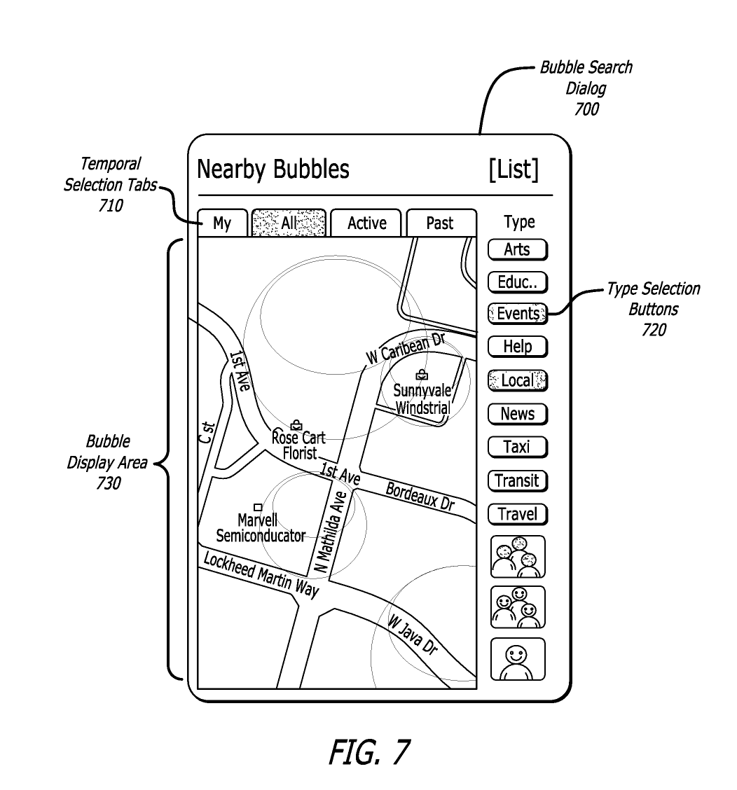

In an embodiment, the bubble creation service can provide a bubble search facilities to enable users to locate nearby bubbles accessible to such users. FIG. 7 illustrates an embodiment of a bubble search dialog 700. The bubble search dialog 700 can include temporal selection tabs 710. The tabs 710 can provide a tab for active bubbles. In an embodiment, active bubbles represent bubbles whose start time has past and whose end time has not yet been reached. Active bubbles represent bubbles that users can sign into and post messages and content.

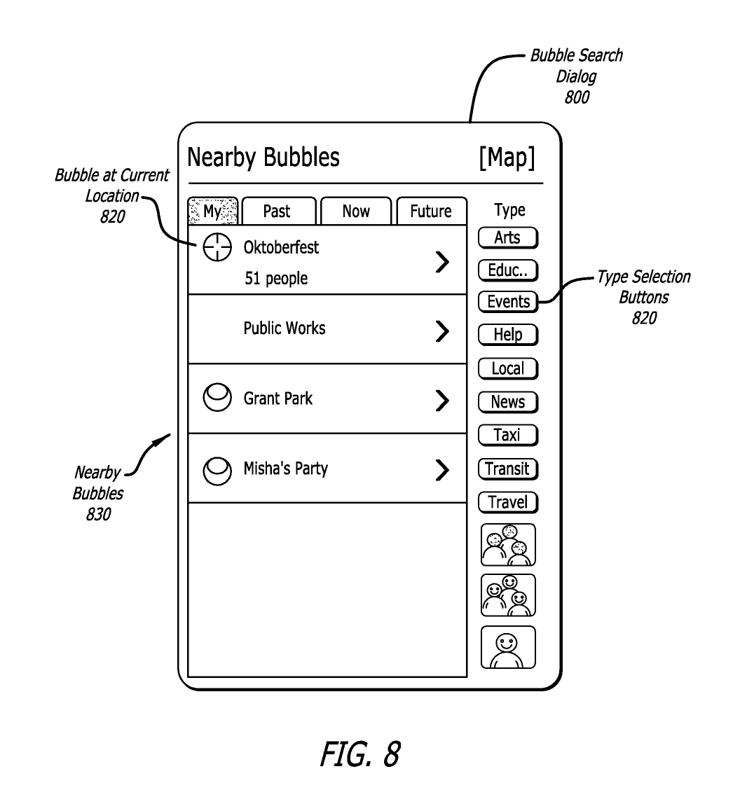

The tabs 710 can additionally provide a tab for past bubbles, that is to say, bubbles whose end time has been reached. Past bubbles represent bubbles that users cannot sign into and post messages and content, but whose content may visible to all users or users who participated in the bubble when the bubble was active. In an embodiment, the past tab displays only bubbles a user participated in while the bubble was active. The tabs 710 can additionally provide a tab for “My” (e.g. “My Bubbles”). An embodiment of a view of a “My” tab is shown in FIG. 8, and described below. The tabs 710 can additionally provide a tab for all bubbles currently visible to the user.

The bubble search dialog 700 can additionally include type selection buttons 720 to allow a user to narrow the number of bubble types selected for display on the bubble search dialog. In the illustrated embodiment, the types “Events” and “Local” are selected.

In an embodiment, bubbles visible to the user that meet temporal and type selection criteria are displayed on a map in the bubble display area 730. In an embodiment, only public bubbles are displayed on the map. In an embodiment, only past bubbles the user participated in are displayed on the map. In an embodiment, private bubbles are not displayed on the map. In an embodiment, private bubbles are a user is actively participating are displayed on the map.

In an embodiment, the map in the bubble display area 730 is centered on the current or last known geospatial location of the user's device. In an embodiment, the map in the bubble display area 730 is centered on a user specified location. In an embodiment, the map in the bubble display area 730 can scroll and zoom in or out. In an embodiment, a user can sign into a bubble by performing a user interface action on the display of the bubble on the map, for example, tapping or clicking.

FIG. 8 illustrates an embodiment of a display of a “My” tab on a bubble search dialog 800. Bubbles are listed in a text list format 820 and 830, as opposed to displayed on a map. In an embodiment, Bubbles on the “My” list could include bubbles a user expressly added to the “My” list or bubbles the user is currently participating in. In the illustrated embodiment, the “Oktoberfest” bubble 820 is flagged with crosshairs to denote the user's current location falls within the bubble. In an embodiment, a user can sign into a bubble by performing a user interface action on the display of the bubble on the list, for example, by tapping or clicking.

In various embodiments bubbles can thus enable proximity based messaging, anonymous messaging and media sharing in a variety of circumstances enabling communication, collaboration, and media sharing with known and unknown people in a user's immediate vicinity. For example, suppose a user goes to a concert, but has a seat that offers a poor view. The user could create (or join) a bubble associated with the concert to see if other users with better seats have posted any photos or video and sees a great photo from the front row and posts the to photo to the FLICKR website. In another example, a bride and groom could set up a private wedding bubble in advance of their beach wedding to enable photo sharing and a virtual guestbook.

Because bubbles are geo-fenced and event-focused (time-boxed), the veracity of communications at an exclusive event such as the Academy Awards, Super Bowl, or even a U2 concert can be verified. Only users with a location verified as being within the circumference of a bubbles may create content within the bubble. This ensures that all content—and all users—are related by their geography.

In an embodiment, users inside a bubble can be allowed to share media, such as photos and video, with third party sites like the FACEBOOK or TWITTER social networking websites, users outside the bubble will only be allowed low-resolution sneak peeks at the contents inside a bubble. This could provide an incentive for nearby users to join the bubble so that they can later download high resolution photos from others inside the bubble

As mentioned above, the content of bubbles can be archived. In an embodiment, a bubble service can provide means for users to search the content of archived bubbles by, for example, user or keyword. In an embodiment, users can search all archived public bubbles for content of interest. In an embodiment, users could be enable to search archived bubbles in which the user participated when such bubbles were active. In an embodiment, users can search all archived public bubbles for content of interest, but are only permitted limited access (e.g. low-resolution images) for bubbles in which they did not participate when such bubbles were active.

In an embodiment, archived bubbles can be used to provide exclusive, persistent connections between users who shared a place and time. In an embodiment, any user who enters a bubble will be able to contact anyone else who was inside the same bubble, even after the bubble is no longer active. If a user joined a bubble at some time in the past, the location of the user has been verified at that time. The start and end time of the bubble create a time box for a persistent connection. The profiles of those who were in the same bubbles be correlated and given the option to connect at a later date.

In an embodiment, users can be given the option to communicate with anyone else who the same bubble in a manner that exposes elements of their profile (e.g. their user ID, name, address, etc.). In an embodiment, users can be given the option to communicate anonymously with anyone else who was in the same bubble, even other anonymous posters. These connections enable communication with individuals who were present at the same time and place. This also provides a incentive for users to join a bubble: users will perceive joining a bubble as a high potential to connect with people at an event, even if they didn't have a chance to talk to them in person and trade contact information.

In an embodiment, users in private, high-trust bubbles may post anonymously but will be dissuaded via the user interface from doing so. This is based on the assumption that it is more likely that people in private bubbles will use the persistent connections feature to permanently associate an event, meeting, conference, etc. with a small group of people who were present, and to gain access to contact information of those people in the bubble.

The use cases for persistent connections range from flirting with people that a user met in a bar, park, party, etc. to more mundane networking applications: joining a private bubble during a large meeting to have access to all attendees' contact information. Various other use cases could be:
After leaving a cafe, a user could ask those still there whether they see the user's umbrella (wallet, purse, etc.) on the table you where the user was sitting.
Conference attendees a convenient way to get in touch with others at a conference, even if the users forgot to exchange business cards.
A guest at a wedding talks with a bridesmaid but forgets her name—the week after the wedding he looks her up in the archived bubble and send her an email.
A father sitting in the stands creates a bubble for his sons little league game—other fathers post photos and videos—father later sends a message via the archived bubble to everyone else in the archived bubble asking whether anyone wants to carpool to the game across town next week.

In an embodiment, bubbles can be nested within bubbles. For example, a bubble for a conference could comprise a cluster of sub-bubbles for each of a plurality of breakout sessions or tracks. A user signing into the bubble would be able to view the various sub-bubbles associated with the conference, although the user may or may not be able to sign into a sub-bubble.

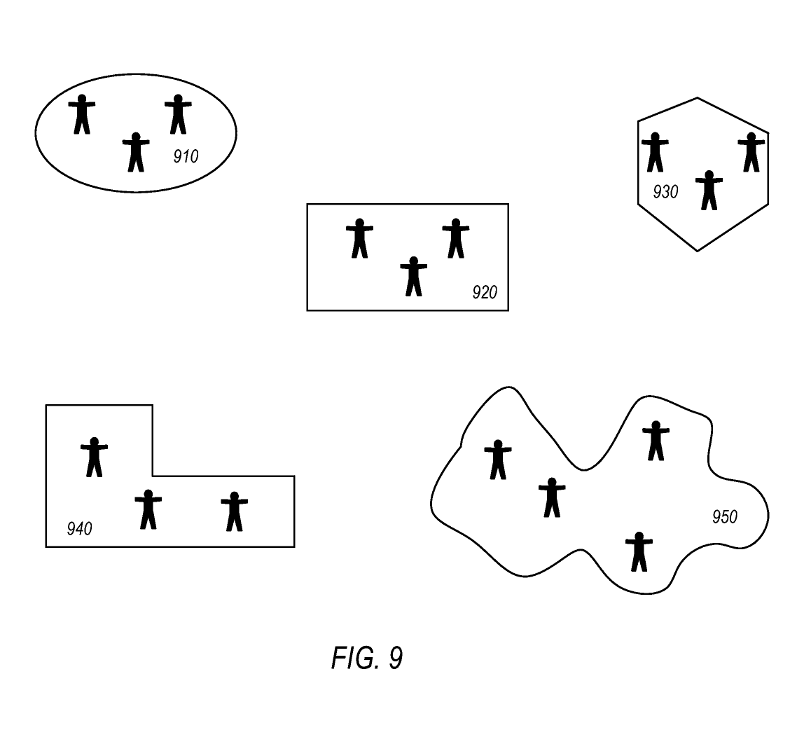

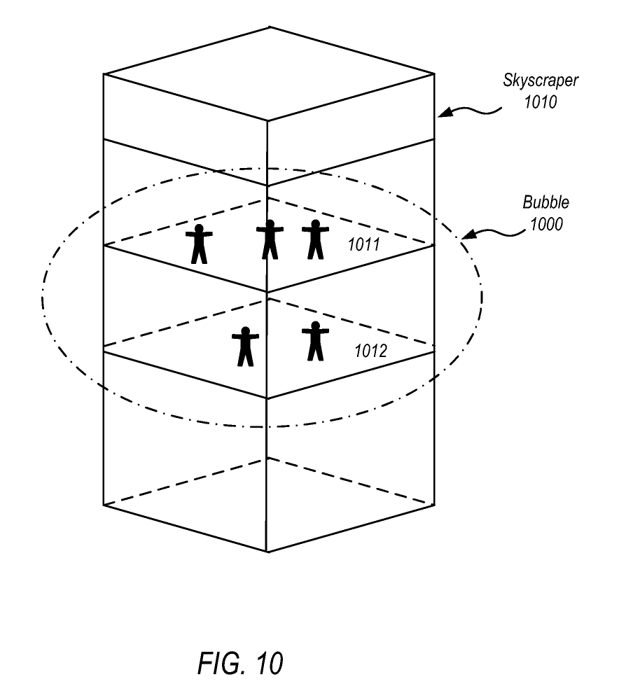

The various embodiments of bubbles illustrated in FIGS. 1 and 7 are shown and described as being bounded by a circle. The possible shapes of a bubble are not intended to be so limited. In an embodiments, bubbles could be bounded by any two-dimensional closed figure. FIG. 9 illustrates a number of possible shapes for a bubble including a oval 910, a rectangle 920 or any other polygonal shape, such as a hexagon 930 or a closed figure representing a floor plan of a building 940 or the seating area of a stadium. Bubbles could even take on amoeboid shape s950. Furthermore, in an embodiment, a bubble could be enclosed by any three-dimensional closed figure having a centroid in three-dimensional space, such as a sphere or a cylinder or a box. Such three-dimensional bubbles could be used for creating a bubble for groups of floors within a skyscraper or stores in a multilevel shopping mall. FIG. 10 illustrates one possible three-dimensional bubble 1000 encompassing two floors 1011 and 1012 of a skyscraper 1010.

The various embodiments of bubbles illustrated in FIGS. 1 and 7 are shown and described as being bounded located at a fixed location. In other embodiments, a bubble could be defined as having a dynamic location that varies over time (e.g. under advanced options). For example, a bubble could be defined as having a location that tracks a moving person, vehicle or mobile device, such as, for example, passengers on a bus or subway train.

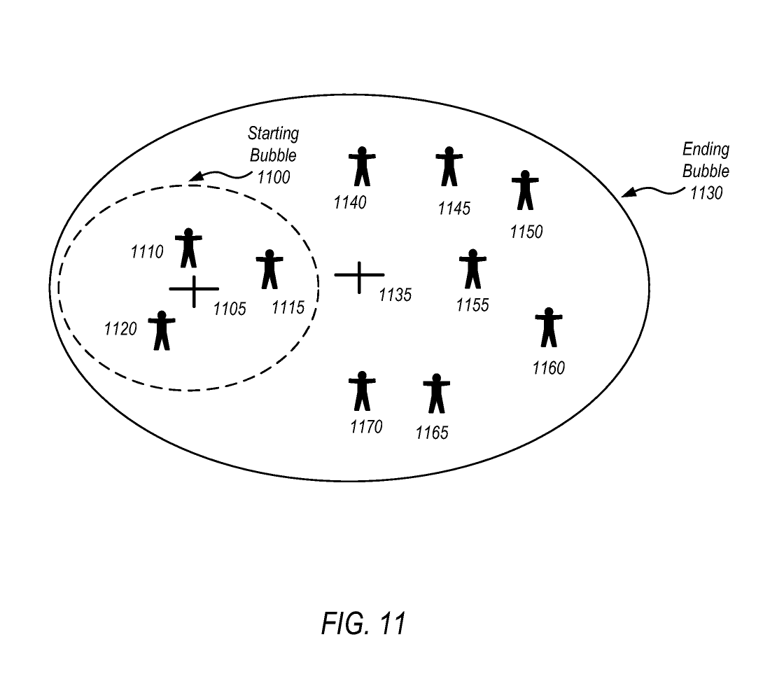

The various embodiments of bubbles illustrated in FIGS. 1 and 7 are shown and described as being having a fixed size. In other embodiments, a bubble could be defined as having a dynamic size and centroid that varies over time (e.g. under advanced options). In one such embodiment, the size and centroid changes of a bubble changes as user join a bubble or move. FIG. 11 illustrates an embodiment of the basic concept. A starting bubble could be initially created by a user 1110. The size of the starting bubble 1100 and the location of its centroid 1105 reflects the position of user 1100.

Sometime later, the bubble is joined by two other users 1115 and 1120. The starting bubble easily accommodates the additional users 1115 and 1120, and hence the boundaries 1100 and the centroid 1105 of the starting bubble do not change. Sometime later, seven additional users 1145-1170 join the bubble. The starting bubble 1100 cannot comfortably accommodate the additional users, and the boundaries of the starting bubble are shifted to the right to create an expanded ending bubble 1130 that can accommodate the additional users. The centroid 1135 of the ending bubble also shifts to the right to reflect the center of the population associated with the bubble. In an embodiment, additional users must actually enter the starting bubble 1100 before they can sign into the bubble, and the boundaries of the bubble are expanded in response to a growing population within the bubble. In an embodiment, additional users may sign into the starting bubble if they are within a predefined proximity of the boundaries of the starting bubble 1100 (e.g. within 20 feet) and the boundaries of the starting automatically expand to include the additional users.

For example, the first tailgater to arrive at a football game may create a bubble around him. As others arrive to tailgate, join the bubble, and eventually move to inside the stadium, the bubble would be required to change dynamically, growing to accommodate the thousands of people in the crowd, and reflecting the movement and virtual centroid of the crowd inside the bubble.

Various factors could be used to vary the size and shape of a bubble, such as,for example, the initial size of the bubble, time that the bubble is active, and a position defined by an algorithmic combination of user selections, geo-location accuracy, number of potential members, number of sub-bubbles, number of existing members, and bubble type.

The creation of public bubbles can create adverting opportunities for businesses. In an embodiment, the contents of public bubbles are visible from outside of bubbles, for example, public bubbles could be searched for content that indicates users within the bubble may be interested in an advertiser's products. In an embodiment, a bubble based advertising system could be created that allows advertisers to search for bubbles within a given geographic area for keywords, key phrases, brands, products and the like. Such a system could support additional criteria such as, for example, date and time ranges, a minimum number of participant or bubble participant demographics.

In an embodiment, the bubble based advertising system could allow advertisers to bid against one another for advertising services based on bubble selection criteria or, alternatively or additionally, to purchase advertising services based on bubble selection criteria for a predetermined fee set by the bubble based advertising service. The system could enable bidding on individual keywords, keyphrases, products, brands or demographic criteria or allow bidding on a combination of some or all of the above. The system could restrict bids to limited geographical areas such as, for example, fifteen-mile radius of a designated geographical point, such as a business location associated with the advertiser. In an embodiment, advertisers could bid for, or purchase, bubble based advertising services on an exclusive basis or non-exclusive basis. Bids could be based on any monetization technique known in the art such as, for example cost-per-click (CPC), cost-per-impression (CPI) or cost-per-action (CPA).

In an embodiment, advertisers can define search criteria that are automatically executed on a periodic or continuous basis. In an embodiment, the system could provide a query interface to allow advertisers to execute queries against active bubbles on-demand.

In an embodiment, when bubbles of interest are identified by bubble selection criteria, advertisements from advertisers interested in the bubble could be automatically sent to users associated with the bubble. Such advertisements could be sent to consumers via any messaging means, including, for example, via email or SMS. Such advertisements could take any form, such as, for example, ad copy, coupons, hyperlinks and so forth. In an embodiment, advertisements could be displayed within the bubble that triggered the advertisement, for example, as a message posted to a message board or an advertisement displayed in a sidebar.

In an embodiment, such advertisements can comprise or lead to monetization events. For example, if an advertiser is paying for advertisements on a CPC basis, the advertiser can be charged when a user clicks on an advertisement or hyperlink in a message or in a bubble. If an advertiser is paying for advertisements on a CPI basis, the advertiser can be charged when an advertisement is transmitted to a user or when an advertisement is displayed in a bubble. If an advertiser is paying for advertisements on a CPA basis, the advertiser can be charged when an a coupon (whether hardcopy or electronic) in an advertisement is redeemed.

Alternatively or additionally, when bubbles of interest are identified, bubble selection criteria, advertisers interested in the bubble could be alerted to the bubbles existence. The advertiser could review the bubble's properties and demographics, and send advertisements to the users associated with the bubble if the advertiser so chooses. In an embodiment, the advertiser could actually sign into the bubble and attempt to engage the users associated with the bubble directly.

In an embodiment, such advertisements could encourage users to sign into a nearby business-sponsored bubble. Such business-sponsored bubbles could simply be a bubble associated with a specific business location, or could be a special purpose bubble for a deal, or a “deal bubble”.

In an embodiment, in order to create business bubbles and deal bubbles, a business owner first registers the business with a bubble adverting service provider and the business is verified as a legitimate business. Once the business has been verified, the business may create deal bubbles associated with that business.

In an embodiment, a deal bubble requires the owner of a verified business to create a sub-bubble that is time-boxed (happy hour), geospatial (at the Polk St. Location only), and could require explicit social interaction or collaboration. For example, the creator of a deal bubble may choose to create a special promotion that attracts people nearby who are close to their business but not yet in the bubble for that business. The deal may be as simple as giving happy hour prices to anyone inside the bubble (in which case the owner simply uses deal bubbles as a means of marketing distribution). A deal bubble may create an incentive for groups to collaborate. For example, the deal bubble could specify that if five customers enter the bubble between 5:00 PM-7:00 PM they may receive a discount code via text message to redeem for a free or deeply discounted product.

In an embodiment, deals can be announced as a specially marked bubble and could, for example, appear on a map view or list view. For example, a deal bubble could be marked with a different color, font, highlighting, or with the logo of the advertiser. In an embodiment, users could elect to suppress the display of deal bubbles. In an embodiment, users cannot elect to suppress the display of deal bubbles, or can only suppress the display of deal bubbles if they pay a subscription fee. In an embodiment, users can opt-in to receive push notifications on their cell phones or smart phoned (text message, popup, etc.) when they are within the immediate proximity of an active deal.

In an embodiment, for deals simply announcing a time-boxed discount, the deal bubble will be active as long as the discount is available. In an embodiment, deal bubbles that require collaboration, or a minimum number of participants will require a verification code. In an embodiment, the verification code can be automatically generated and sent to the business owner (or manager, waiter, bartender), and will only appear when enough people join the bubble to activate the deal.

For example, while waiting for the check at a restaurant, a user opens a local application to see nearby event bubbles. She realizes that a bar nearby, “Elixir”, has an active bubble with a happy hour deal that will be activated if five people join the bubble. She goes to the bar with four friends and recruits them to join the bubble. All users and bartender receive a unique verification code that confirms there are enough people in the bubble to qualify for the deal. Another user who lives nearby is on his laptop checking the for things to do and gets an alert that that Elixir's happy hour deal bubble has been activated. He walks a couple of blocks to the bar before the deal bubble expires.

In another example, the owner of a pizzeria checks the bubbles app on his smart phone and sees that there are twenty people participating in a little league baseball game at a park nearby. He immediately creates a deal bubble offering a discount for groups of ten or more people who check into the bubble between 4:00 PM and 6:00 PM. When one of the parents sees the discount, they decide to round up other parents to join them for pizza after the game instead of going for burgers.

User interactions with deal bubbles could comprise monetization events. For example, a user signing into a deal bubble, redeeming a coupon within a deal bubble or qualifying for a promotion offered in a deal bubble could be monetization events.

In an embodiment, deal bubbles can be automatically created on the basis of some event. For example, a deal bubble could be automatically created when a user creates a bubble that matches bubble selection criteria. In another example, a deal bubble could be automatically created when a known competitor creates a deal bubble. In another example, a deal bubble could be automatically created when a nearby business creates a deal bubble relating to a specific product. The automatic creation of a deal bubble could be a monetization event.

In an embodiment, deal bubbles could be configured to for passing coupons or deals between users via NFC. For example, a user signed into a deal bubble could touch phones with a second user and the second user is automatically logged into the bubble.

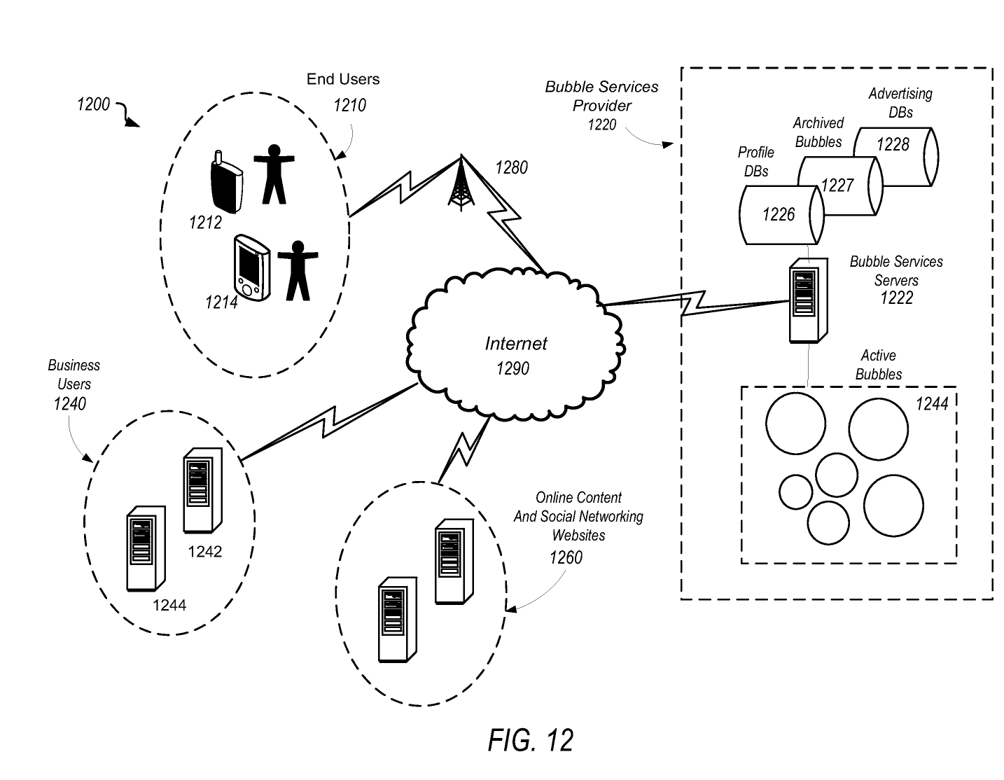

FIG. 12 illustrates a high-level view of an embodiment of a system 1200 capable of supporting various embodiments of the systems and methods described herein. End users 1210 have mobile devices 1212 and 1214, for example, cell phones and smart phones connected to the Internet 1290 via one or more data networks 1280, such as CDMA or G4 wireless networks. The current geospatial location of the mobile devices 1212 and 1214 can be determined to greater or lesser degree of accuracy. In an embodiment, the devices 1212 and 1214 could be capable of determining their own geospatial location via, for example, GPS capabilities. Additionally or alternatively, the current geospatial location of the mobile devices 1212 and 1214 could be determined using capabilities inherent in the data networks 1280 such as triangulation of cell signals or the location of the nearest cell tower.

Various bubble services are, such as those described above, provided by a bubble service provider 1220. One or more bubble service servers 1222 provide services that include bubble creation, bubble search services, bubble archive service and bubble based advertising services. In response to requests from end users, the bubble service servers 1222 create active bubbles 1224. In an embodiment, data relating to and defining active bubbles are stored in a computer-readable storage 1224 such as, for example RAM associated with the servers 1222. The bubble services servers 1222 provide various social networking functions that allow users 1210 to search for, interact with bubbles as described above, and verify that users are located within the boundaries of bubbles with which they are interacting.

The system stores profiles relating to, inter alia, individual users 1210, and businesses 1240 on one or more profile DBs. In an embodiment, the bubble service servers 1222 archive data relating to bubbles once the bubbles expire. In an embodiment, the bubble service servers 1222 archive provide facilities to search archived data relating to bubbles by, for example, keyword, keyphrase or user.

In an embodiment, the bubble service servers 1222 provide bubble based advertising services that allow business users to bid on or purchase bubble based advertising services as described above. In an embodiment, business users interact with the bubble services servers over the Internet 1290. Devices used by businesses 1242 and 1244 may or may not be mobile or location aware. In an embodiment, a business can be associated with one or more locations via, for example, profile data stored on profile DBs 1226 and can create bubbles located in such locations. Data relating to bubble based advertising services, such as advertisements, bids, and monetizing events are stored, in an embodiment, one or more advertising databases.

In an embodiment, services provided by the bubble service servers 1222 can allow users to post content posted to bubbles to social networking sites 1260 such as FACEBOOK or TWITTER or to online content websites such as FLICKR.

The system shown in FIG. 12 is purely illustrative. Those skilled in the art will appreciate that a number of alternate configurations could provide the functions provided by the system in FIG.12. For example, services provided by bubble services servers 1420 could be distributed across multiple servers controlled by more than one entity. For example, online content servers 1222 and databases 1226-28 could represent virtual servers and cloud-based data storage provided by one or more cloud-based services entities.

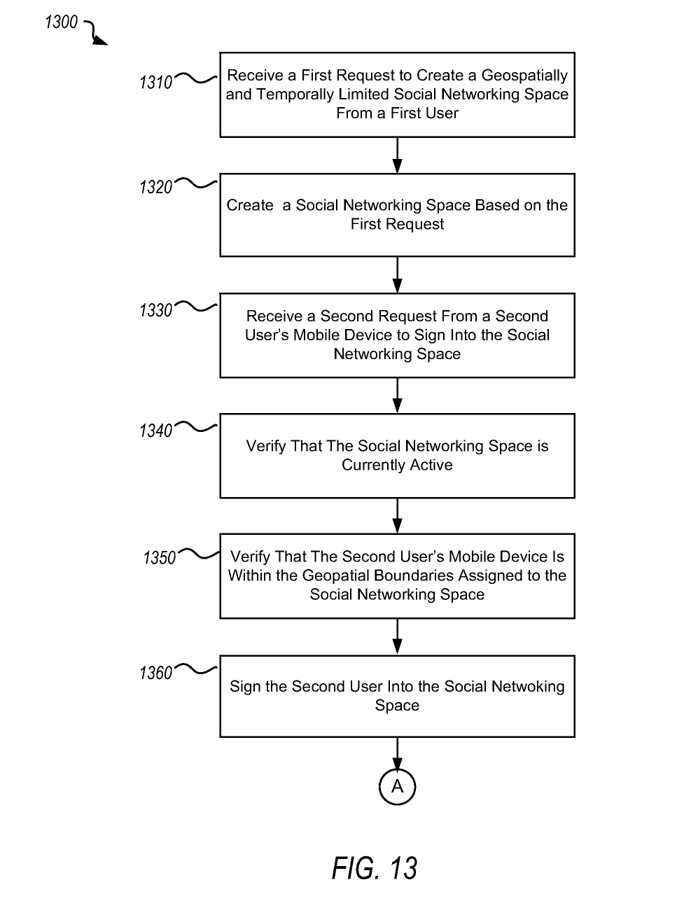

FIG. 13 illustrates a computer-implemented process 1300 for creating a geospatially and temporally limited social networking space. Unless otherwise specified, it should be understood that the processing described with respect to each of the blocks of FIG. 13 is performed by at least one computing device maintained or controlled by a bubble services provider. In an embodiment, such a computing device could be one or more of the bubble services servers 1222 of FIG. 12.

In block 1310, a first request is received from a first user, over a network, to create a geospatially and temporally limited social networking space. In an embodiment, the first request comprises a geospatial location, a start time, and an end time. In an embodiment, the geospatial location can comprise a closed two-dimensional or three-dimensional geometric figure centered on a geospatial point. In an embodiment, the request could also comprise other parameters such as, for example, a type, a designation of the requested social networking space as public or private, an indication that a user is required to ask the creator of the social networking space to enter the space, and other advanced options, such as disabling anonymous messaging and/or indicating that the location and/or size of the geospatial location associated with the social networking space is dynamic.

In block 1320, social networking space is created based on the first request, such that the social networking space is associated with the geospatial location, the start time, and the end time specified in the request. In an embodiment, the social networking space comprises facilities for posting messages visible to users signed into the social networking space. In various other embodiments, the social networking space can provide any functions associated with social networking websites now known, or later to be developed. In an embodiment, as described in greater detail above, the system can additionally provide facilities to search for active and/or archived geospatially and temporally limited social networking spaces once such social networking spaces are created. In an embodiment, social networking spaces designated as private can be excluded from search results

In block 1330, a second request is received, over the network, from a second user to sign into the social networking space. In an embodiment, the second request is transmitted from a mobile device associated with the second user. In an embodiment, the request can be transmitted by any device whose geospatial location can be determined such as, for example, a fixed computer at a known location or a mobile device.

In block 1340, it is verified that the social networking space is currently active. In an embodiment, a social network is considered active if the current time falls between the start time and the end time associated with the social networking space.

In block 1350, it is then verified that the second user's mobile device is within spatial boundaries assigned to the social networking space. In an embodiment, it is verified that the current geospatial position of the mobile device is within the geospatial location associated with the social networking space.

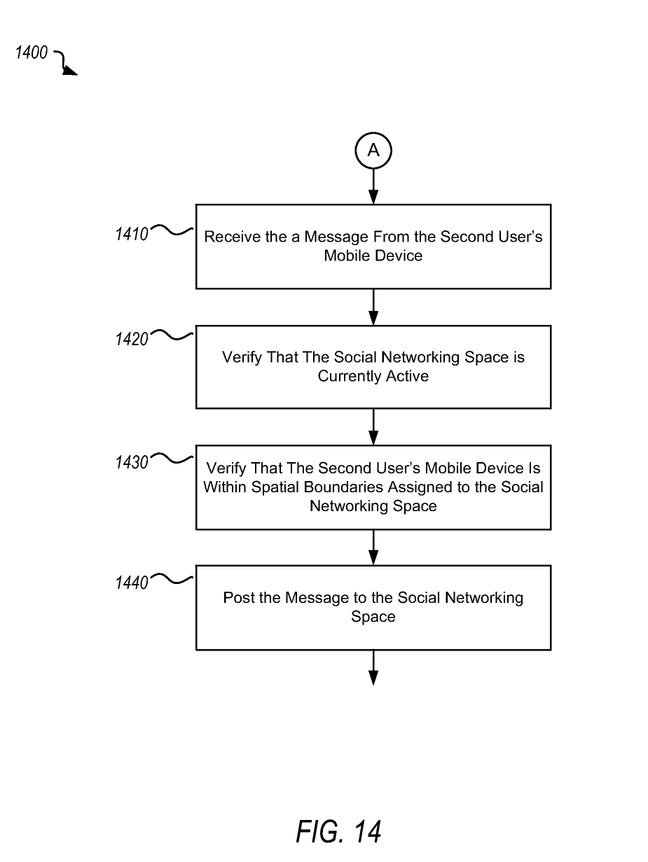

In block 1360, assuming that the social networking space is active and the second user's device is within the geospatial boundaries assigned to the social networking space, the second user is signed into the social networking space, and the second user is able to participate in various activities within the space. One such activity comprises posting messages to the social networking space, as described below with respect to FIG. 14. Other activities could include, for example, viewing messages posted by other users or voting on messages posted by other users.

FIG. 14 illustrates a computer-implemented process 1400 for posting messages to geospatially and temporally limited social networking space. Unless otherwise specified, it should be understood that the processing described with respect to each of the blocks of FIG. 14 is performed by at least one computing device maintained or controlled by a bubble services provider. In an embodiment, such a computing device could be one or more of the bubble services servers 1222 of FIG. 12. The method as shown presumes a second user is signed into the social networking space via, for example, the method shown in FIG. 13 and described above.

In block 1410, a message from the second user is received from the second user's mobile device. In an embodiment, the message comprises a text message. In an embodiment, the message comprises a text object. In an embodiment, the message comprises a multimedia object.

In block 1420, it is verified that the social networking space is currently active. In an embodiment, a social network is considered active if the current time falls between the start time and the end time associated with the social networking space.

In block 1430, it is then verified that the second user's mobile device is within spatial boundaries assigned to the social networking space. In an embodiment, it is verified that the current geospatial position of the mobile device is within the geospatial location associated with the social networking space.

In block 1440, assuming that the social networking space is active and the second user's device is within the geospatial boundaries assigned to the social networking space at the time the message is sent, the message is posted to the social networking space such that the message is visible to other users signed into the social networking space. In an embodiment, the message is posted with a signature designated by the second user. In an embodiment, such a signature can comprise a user ID associated with a user profile for the second user. In an embodiment, such a signature can comprise an anonymous signature.

If the social networking space is not active, for example, if the current time does not fall between the start time and the end time associate with the social networking space, the system can take a number of actions. In an embodiment, the system automatically signs the second user off the social networking space. In an embodiment, the system automatically disables the second user from posting messages to the social networking space but may, for example, allow the second user to view messages posted to the social networking space.

If the second user's mobile device is not within the spatial boundaries assigned to the social networking space, for example, the current geospatial position of the second users mobile device does not fall within the geospatial location associated with the social networking space, the system can take a number of actions. In an embodiment, the system automatically signs the second user off the social networking space.

In an embodiment, once a social networking space becomes inactive (e.g. the current time is greater that the end time associated with the social networking space), the contents of the social networking space, including messages and user profile information is archived. In an embodiment, the contents of such archived social networking spaces can be searched as described in greater detail above. In an embodiment, the contents of such archived social networking spaces can used by participants in the archived social networking spaces to contact one another as described in greater detail above.

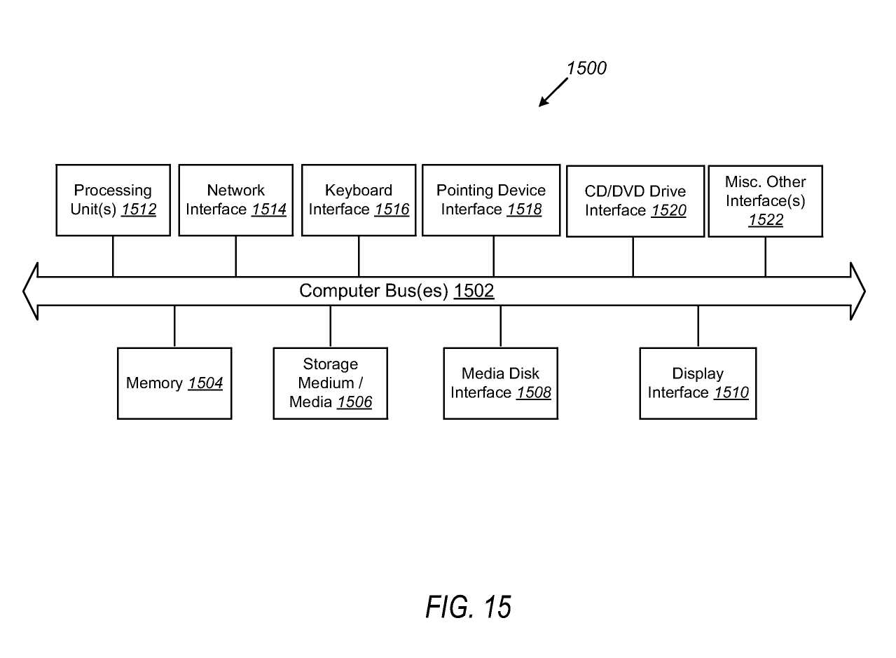

FIG. 15 is a block diagram illustrating an internal architecture of an example of a computing device. In an embodiment, FIG. 15 could represent the internal architecture of the bubble services servers 1420 of FIG. 13 in accordance with one or more embodiments of the present disclosure. A computing device as referred to herein refers to any device with a processor capable of executing logic or coded instructions, and could be a server, personal computer, set top box, smart phone, pad computer or media device, to name a few such devices.

As shown in the example of FIG. 15, internal architecture 1500 includes one or more processing units (also referred to herein as CPUs) 1512, which interface with at least one computer bus 1502. Also interfacing with computer bus 1502 are persistent storage medium/media 1506, network interface 1514, memory 1504, e.g., RAM, run-time transient memory, read only memory (ROM), etc., media disk drive interface 1508 as an interface for a drive that can read and/or write to media including removable media such as floppy, CD-ROM, DVD, etc. media, display interface 1510 as interface for a monitor or other display device, keyboard interface 1516 as interface for a keyboard, pointing device interface 1518 as an interface for a mouse or other pointing device, and miscellaneous other interfaces not shown individually, such as parallel and serial port interfaces, a universal serial bus (USB) interface, and the like.

Memory 1504 interfaces with computer bus 1502 so as to provide information stored in memory 1504 to CPU 1512 during execution of software programs such as an operating system, application programs, device drivers, and software modules that could comprise program code that, when executed by CPU 1512, perform the processing described with respect to the blocks of FIGS. 13 and 14 above. CPU 1512 first loads computer-executable process steps from storage, e.g., memory 1504, storage medium/media 1506, removable media drive, and/or other storage device. CPU 1512 can then execute the stored process steps in order to execute the loaded computer-executable process steps. Stored data, e.g., data stored by a storage device, can be accessed by CPU 1512 during the execution of computer-executable process steps.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

We claim:

1. A method comprising:
receiving, over a network, from a first user, a first request for a creation of a social networking space, the first request comprising a geospatial location, a start time, and an end time;
creating, using a computing device, a social networking space based on the request, the social networking space comprising facilities for posting messages visible to users signed into the social networking space;
receiving, over the network, a second request from a second user to sign into the social networking space, such that the second request is transmitted from a mobile device associated with the second user;
verifying, using the computing device, that a first current time falls between the start time and the end time;
verifying, using the computing device, that a first current geospatial position of the mobile device is within the geospatial location; and
in response to verifying the first current time and the first current geospatial position, signing, using the computing device, the second user into the social networking space.

2. The method of claim 1 additionally comprising:
receiving, via the network, a message from the second user, such that the message is transmitted from a mobile device associated with the second user;
verifying, using the computing device, that a second current time falls between the start time and the end time;
verifying, using the computing device, that a second current geospatial position of the mobile device is within the geospatial location; and
in response to verifying the second current time and the second current geospatial position, posting, using the computing device, the message to the social networking space such that the message is visible to other users signed into the social networking space.

3. The method of claim 2 additionally comprising:
in response to determining the second current time does not fall between the start time and the end time, automatically, using the computing device, signing the second user off of the social networking space.

4. The method of claim 2 additionally comprising:
in response to determining the second current time does not fall between the start time and the end time, automatically, using the computing device, disabling the second user from posting messages to the social networking space.

5. The method of claim 2 additionally comprising:
in response to determining second current geospatial position does not fall within the geospatial location, automatically, using the computing device, signing the second user off of the social networking space.

6. The method of claim 2 wherein the message comprises a text message.

7. The method of claim 2 wherein the message comprises multimedia content.

8. The method of claim 1 wherein the geospatial location comprises a closed geometric figure centered on a geospatial point.

9. The method of claim 1 wherein the closed geometric figure is a two-dimensional figure.

10. The method of claim 1 wherein the closed geometric figure is a three-dimensional figure.

11. The method of claim 1 wherein the message is posted with a signature designated by the second user.

12. The method of claim 1 wherein the signature designated by the second user comprises a user ID associated with a user profile for the second user.

13. The method of claim 1 wherein the designated by the second user comprises an anonymous signature.

14. The method of claim 1 additionally comprising:
receiving, over the network, a third request from third user to search for social networking spaces, the third request comprising search criteria, such that the third request is transmitted from a mobile device associated with the third user;
searching, using the computing device, for social networking spaces that satisfy the search criteria;
determining, using the computing device, that the social networking space meets the search criteria of the third request; and
in response to determining that the social networking space meets the search criteria of the third request, causing, using the computing device, a representation of the social networking space to be displayed on the mobile device associated with the third user.

15. The method of claim 14 wherein the search criteria comprises a geospatial location, such that in response to determining that the geospatial location of the social networking space falls within the geospatial area of the third request, a representation of the social networking space is caused to be displayed on the mobile device associated with the third user.

16. The method of claim 14 wherein the search criteria additionally comprises a keyword, such that in response to determining that the geospatial location of the social networking space falls within the geospatial area of the third request and the message comprises the keyword of the third request, a representation of the social networking space is caused to be displayed on the mobile device associated with the third user.

17. The method of claim 14 wherein the geospatial location comprises a closed geometric figure centered on a geospatial point, wherein the representation of the social networking space comprises a representation of the closed geometric figure displayed on a map such that the geospatial point is located on the map.

18. The method of claim 14 wherein the first request for a creation of the social networking space additionally indicates the social networking space is private, wherein the social networking space is created as a private social networking space, the method additionally comprising:
determining, using the computing device, that the social networking space is a private social networking space; and
in response to determining that the that the social networking space is a private social networking space, a representation of the social networking space is not caused to be displayed on the mobile device associated with the third user.

19. The method of claim 1 additionally comprising:
determining, using the computing device, that a third current time is later than the end time; and
in response to determining that a third current time is later than the end time, creating, using the computing device, an archive of the social networking space, the archive comprising the geospatial location, the start time, and the end time and the message.

20. The method of claim 1 additionally comprising:
receiving, over the network, a third request from third user to search for archives of social networking spaces, the third request comprising search criteria, such that the third request is transmitted from a mobile device associated with the third user;
searching, using the computing device, for archives of social networking spaces that satisfy the search criteria
determining, using the computing device, that the archive of the social networking space satisfies the search criteria; and
in response to determining that the archive of the social networking space satisfies the search criteria, causing, using the computing device, a representation of the archived social networking space to be displayed on the mobile device associated with the third user.

21. The method of claim 20 wherein the search criteria comprises a geospatial location, such that in response to determining that the geospatial location of the archive of the social networking space falls within the geospatial area of the third request, a representation of the archive of the social networking space is caused to be displayed on the mobile device associated with the third user.

22. The method of claim 20 wherein the search criteria additionally comprises a keyword, such that in response to determining that the geospatial location of the archive of the social networking space falls within the geospatial area of the third request and the message of the archive of the social networking space comprises the keyword of the third request, a representation of the social networking space is caused to be displayed on the mobile device associated with the third user.

23. The method of claim 20 additionally comprising:
determining, using the computing device, that the archive of the social networking space is an archive of a private social networking space;
determining, using the computing device, that the third user did not participate in the social networking space;
in response to determining that the third user did not participate in the social networking space a representation of the archived social networking space is not displayed on the mobile device associated with the third user.

24. The method of claim 19 wherein the archive of the social networking space additionally comprises a profile for the second user comprising contact information for the second user, the method further comprising:
receiving, over the network, a third request from third user to send an electronic message to the second user, the third request comprising an identification of the archived social networking space, an identification of the second user, and electronic message content;
retrieving, using the computing device, the archive of the social networking space, using the identification of the archived social networking space;
determining, using the computing device, that the third user participated in the social networking space;
extracting, using the computing device, the contact information for the second user from the archive of the social networking space, using the identification of the second user;
in response to determining that the third user participated in the social networking space:
extracting, using the computing device, the contact information for the second user from the archive of the social networking space, using the identification of the second user;
sending an electronic message, using the computing device, to the second user, using the contact information for the second user, the electronic message comprising the electronic message content.

25. The method of claim 24 wherein the electronic message is signed with profile information for the third user.

26. The method of claim 24 wherein the electronic message is signed as anonymous.

27. A computing device comprising:
a processor;
a storage medium for tangibly storing thereon program logic for execution by the processor, the program logic comprising:
logic executed by the processor for receiving, over a network, from a first user, a first request for a creation of a social networking space, the first request comprising a geospatial location, a start time, and an end time;
logic executed by the processor for creating a social networking space based on the request, the social networking space comprising facilities for posting messages visible to users signed into the social networking space;
logic executed by the processor for receiving, over the network, a second request from a second user to sign into the social networking space, such that the second request is transmitted from a mobile device associated with the second user;
logic executed by the processor for verifying that a first current time falls between the start time and the end time;
logic executed by the processor for verifying that a first current geospatial position of the mobile device is within the geospatial location; and
logic executed by the processor for in response to verifying the first current time and the first current geospatial position, signing the second user into the social networking space.

28. The computing device of claim 27 additionally comprising:
logic executed by the processor for receiving, via the network, a message from the second user, such that the message is transmitted from a mobile device associated with the second user;
logic executed by the processor for verifying that a second current time falls between the start time and the end time;
logic executed by the processor for verifying that a second current geospatial position of the mobile device is within the geospatial location; and
logic executed by the processor for, in response to verifying the second current time and the second current geospatial position, posting the message to the social networking space such that the message is visible to other users.

29. Computer-readable storage media for tangibly storing thereon computer-readable instructions for a method comprising:
receiving, over a network, from a first user, a first request for a creation of a social networking space, the first request comprising a geospatial location, a start time, and an end time
creating a social networking space based on the request, the social networking space comprising facilities for posting messages visible to users signed into the social networking space;
receiving, over the network, a second request from a second user to sign into the social networking space, such that the second request is transmitted from a mobile device associated with the second user;
verifying that a first current time falls between the start time and the end time;
verifying that a first current geospatial position of the mobile device is within the geospatial location; and
in response to verifying the first current time and the first current geospatial position, signing the second user into the social networking space.

30. The computer-readable storage media of claim 29 wherein the method additionally comprises:
receiving, via the network, a message from the second user, such that the message is transmitted from a mobile device associated with the second user;
verifying that a second current time falls between the start time and the end time;
verifying that a second current geospatial position of the mobile device is within the geospatial location; and
in response to verifying the second current time and the second current geospatial position, posting the message to the social networking space such that the message is visible to other users signed into the social networking space.
